(19) United States
(12) Patent Application Publication
(10) Pub. No.: US 2020/0010760 A1
(43) Pub. Date: Jan. 9, 2020

(54) LIGHT SOURCE DEVICE

(71) Applicant: Panasonic Intellectual Property Management Co., Ltd., Osaka (JP)

(72) Inventors: YUKI UEDA, Osaka (JP); MASAYUKI HOGIRI, Osaka (JP); YOSHIHISA NAGASAKI, Osaka (JP); KOJIRO OKUYAMA, Nara (JP); MITSURU NITTA, Kyoto (JP)

(21) Appl. No.: 16/483,401

(22) PCT Filed: Feb. 22, 2018
(86) PCT No.: PCT/JP2018/006343

§ 371 Date: Aug. 2, 2019

(30) Foreign Application Priority Data
Mar. 8, 2017 (JP) 2017-044098

(51) Int. Cl. C09K 11/77; F21V 9/38; C09K 11/08; C09K 11/64; C09K 11/59

(52) U.S. Cl. CPC C09K 11/7769; F21V 9/38; C09K 11/77; F21Y 2115/10; C09K 11/646; C09K 11/59; C09K 11/0883

(57) ABSTRACT

A light source device includes an excitation light source, and a fluorescence layer configured to emit fluorescence by receiving excitation light emitted from the excitation tight source. The fluorescence layer includes at least one selected from a group consisting of a first fluorescent substance and a second fluorescent substance. The first fluorescent substance is configured to emit fluorescence having a peak wavelength ranging :from 400 nm to 510 nm, inclusive, by receiving the excitation light. The second fluorescent substance is configured to emit fluorescence having a peak wavelength ranging from 580 nm to 700 nm, inclusive, by receiving the excitation light. The first fluorescent substance and the second fluorescent substance each have a fluorescence lifetime ranging from 0.1 nanoseconds to 250 nanoseconds, inclusive. Energy density of the excitation light is 10 W/mm² or more.

### TECHNICAL FIELD

The present disclosure relates to a light source device.

### BACKGROUND

As a light source device configured to emit white light, such a light source device is known that includes an excitation light source and fluorescent substance. The excitation light source emits blue light, for example. The fluorescent substance emits yellow fluorescence by absorbing the blue light emitted from the excitation light source. The light source device emits white light by mixing the blue light and the yellow light.

PTLs 1 and 2 each disclose a light-emitting diode (LED) device including a light-emitting diode chip and fluorescent substance. The fluorescent substance described in PTL 1 is configured to emit yellow fluorescence. The fluorescent substance is yttrium-aluminum-garnet-based fluorescent substance containing cerium. The fluorescent substance described in PTL 2 is configured to emit red fluorescence. A host crystal of the fluorescent substance is an inorganic chemical compound having a crystal structure identical to a crystal structure of CaSiAlN₃. A light emission center of the fluorescent substance is Eu, for example.

### CITATION LIST

### Patent Literature

PTL 1: Unexamined Japanese Patent Publication No. 10-242513

PTL 2: Unexamined Japanese Patent Publication No. 2006-8721

### SUMMARY

A light source device according to the present disclosure includes an excitation light source, and a fluorescence layer configured to emit fluorescence by receiving excitation light emitted from the excitation light source. The fluorescence layer includes at least one selected from a group consisting of a first fluorescent substance and a second fluorescent substance. The first fluorescent substance is configured to emit fluorescence having a peak wavelength ranging from 400 inn to 510 nm, inclusive, by receiving the excitation light. The second fluorescent substance is configured to emit fluorescence having a peak wavelength ranging from 580 nm to 700 nm, inclusive, by receiving the excitation light. The first fluorescent substance and the second fluorescent substance each have a fluorescence lifetime ranging from 0.1 nanoseconds to 250 nanoseconds, inclusive. Energy density of the excitation light is 10 W/mm² or more.

With the light source device according to the present disclosure, light having high brightness and superior in color rendering property can be obtained.

### BRIEF DESCRIPTION OF DRAWINGS

FIG. 1 is a diagram illustrating configuration of a light source device according to a first exemplary embodiment.

FIG. 2 is a graph showing a peak wavelength of light emitted from each fluorescent substance and a fluorescence lifetime of the each fluorescent substance.

FIG. 3 is a graph showing, for each fluorescence lifetime of fluorescent substances, a relationship between energy density of excitation light and a maintenance factor of internal quantum efficiency of the fluorescent substance.

FIG. 4 is a diagram illustrating configuration of a light source device according to a second exemplary embodiment.

FIG. 5 is a diagram illustrating configuration of a light source device according to a third exemplary embodiment.

FIG. 6 is a diagram illustrating configuration of a light source device according to a fourth exemplary embodiment.

FIG. 7 is a diagram illustrating configuration of a light source device according to a fifth exemplary embodiment.

FIG. 8 is a graph showing a relationship between energy density of excitation light and a Commission Internationale de l'Eclairage (CIE) chromaticity coordinate of light emitted from each of wavelength conversion members serving as Samples 1 and 2.

FIG. 9 is a graph showing a relationship between the energy density of the excitation light and the CIE chromaticity coordinate of the light emitted from each of the wavelength conversion members serving as Samples 1 and 2.

FIG. 10 is a graph showing a change in CIE chromaticity coordinate of the light emitted from each of the wavelength conversion members serving as Samples 1 and 2.

### DESCRIPTION OF EMBODIMENT

The light-emitting diodes described in PTLs 1 and 2 can be further improved in terms of brightness and a color rendering property of light to be emitted.

The present disclosure provides a technique for obtaining light having high brightness and superior in color rendering property.

### (Knowledge Underlying the Present Disclosure)

As energy density of excitation light emitted from an excitation light source increases, intensity (brightness) of light emitted from fluorescent substance increases. When the energy density of the excitation light exceeds a certain value, the intensity of the light emitted from the fluorescent substance stops increasing. That is, the intensity of the light emitted from the fluorescent substance saturates. Saturation of intensity of light emitted from fluorescent substance varies depending on a fluorescence lifetime of each of the fluorescent substances. As a fluorescence lifetime of a fluorescent substance extends longer, it becomes difficult to increase intensity of light to be emitted from the fluorescent substance. Thus, a fluorescent substance having a relatively long fluorescence lifetime faces difficulty in emitting light with high intensity; compared with a fluorescent substance having a short fluorescence lifetime. In a case where fluorescent substance having a relatively long fluorescence lifetime and fluorescent substance having a short fluorescence lifetime are combined each other, there would be a problem that light emitted from a light source device is inferior in color rendering property.

A light source device according to a first aspect of the present disclosure includes an excitation light source, and a fluorescence layer configured to emit fluorescence by receiving excitation light emitted from the excitation light source. The fluorescence layer includes at least one selected. from a group consisting of a first fluorescent substance and a second fluorescent substance. The first fluorescent substance is configured to emit fluorescence having a peak wavelength ranging :from 400 nm to 510 nm, inclusive, by receiving the excitation light. The second fluorescent substance is configured to emit fluorescence having a peak wavelength ranging from 580 nm to 700 nm, inclusive, by receiving the excitation light. The first fluorescent substance and the second fluorescent substance each have a fluorescence lifetime ranging from 0.1 nanoseconds to 250 nanoseconds, inclusive. Energy density of the excitation light is 10 W/mm² or more.

According to the first aspect, the excitation light source emits excitation light having greater energy density. The first fluorescent substance or the second fluorescent substance receives the excitation light to emit fluorescence. Since the respective fluorescence lifetimes of the first fluorescent substance and the second fluorescent substance are short, the first fluorescent substance and the second fluorescent substance can respectively emit light at high intensity. That is, the light source device can emit light at high brightness. In a case where the light source device includes other fluorescence layers, the light source device can emit light with a superior color rendering property. That is, the light source device can emit light at high brightness with a superior color rendering property.

A light source device according to a second aspect of the present disclosure includes an excitation light source, and a fluorescence layer configured to emit fluorescence by receiving excitation light emitted from the excitation light source. The fluorescence layer includes at least one selected from a group consisting of a first fluorescent substance and a second fluorescent substance. The first fluorescent substance is configured to emit fluorescence having a peak wavelength ranging from 400 nm to 510 nm, inclusive, by receiving the excitation light. The second fluorescent substance is configured to emit fluorescence having a peak wavelength ranging from 580 nm to 700 nm, inclusive, by receiving the excitation light. The first fluorescent substance and the second fluorescent substance each have a fluorescence lifetime ranging from 0.1 nanoseconds to 250 nanoseconds, inclusive. A difference between the peak wavelength of the fluorescence emitted by the first fluorescent substance and a peak wavelength of the excitation light falls within a range from 20 nm to 200 nm, inclusive. A difference between the peak wavelength of the fluorescence emitted by the second fluorescent substance and the peak wavelength of the excitation light falls within a range from 20 nm to 350 nm, inclusive.

According to the second aspect, the respective fluorescence lifetimes of the first fluorescent substance and the second fluorescent substance are short.

When energy density of excitation light from the excitation light source is high, the first fluorescent substance and the second fluorescent substance can therefore emit light at high intensity. That is, the light source device can emit light at high brightness. In a case where the light source device includes other fluorescence layers, the light source device can emit light with a superior color rendering property. That is, the light source device can emit light at high brightness with a superior color rendering property.

The first fluorescent substance of the light source device according to the present disclosure may contain a chemical compound represented by Lu₃(Ga₁₋ₓAlₓ)₅O₁₂:Ce³⁺ (0≤x≤1). The light source device can therefore emit light at high brightness with a superior color rendering property.

The first fluorescent substance of the light source device according to the present disclosure may contain at least one selected from a group consisting of a chemical compound represented by Y₃Sc₂(Ga_{1-y}Al_{y})₃O₁₂:Ce³⁺ (0≤y≤1) and a chemical compound. represented by (C_{1-z}RE_{z})₃(Zr_{1-w}Sc_{w})₂Sc₃O₁₂:Ce³⁺ (0≤z≤1, 0≤w≤1, and RE includes at least one selected. :from a group consisting of Lu, Y, and Gd). The light source device can therefore emit light at high brightness with a superior color rendering property.

The second fluorescent substance of the light source device according to the present disclosure may contain a chemical compound represented by La₃(Si₆₋ₛ, Alₛ)N_{11-(1/3)s}:Ce³⁺ (0≤s≤1). The light source device can therefore emit light at high brightness with a superior color rendering property.

The second fluorescent substance of the light source device according to the present disclosure may contain a chemical compound represented by Lu₂CaMg₂Si₃O₁₂:Ce³⁺. The light source device can therefore emit light at high brightness with a superior color rendering property.

The second fluorescent substance of the light source device according to the present disclosure may contain a chemical compound represented by (Ca, Sr, Ba, Mg)AlSiN₃:Ce³⁺. The light source device can therefore emit light at high brightness with a superior color rendering property.

The second fluorescent substance of the light source device according to the present disclosure may contain at least one selected from a group consisting of a chemical compound represented by CaSiN₂:Ce³⁺, a chemical compound represented by Sr₃Sc₄O₉:Ce³⁺, and a chemical compound. represented by GdSr₂AlO₅:Ce³⁺. The light source device can therefore emit light at high brightness with a superior color rendering property.

The fluorescence layer of the light source device according to the present disclosure may further include a first matrix surrounding the first fluorescent substance. The first fluorescent substance therefore stably have a shape as an aggregate. The fluorescence layer is superior in heat-resisting property.

The first matrix of the light source device according to the present disclosure may contain ZnO. The first fluorescent substance therefore stably have a shape as an aggregate. The fluorescence layer is superior in heat-resisting property.

The fluorescence layer of the light source device according to the present disclosure may further include a second matrix surrounding the second fluorescent substance. The second fluorescent substance therefore stably have a shape as an aggregate. The fluorescence layer is superior in heat-resisting property.

The second matrix of the light source device according to the present disclosure may contain ZnO. The second fluorescent substance therefore stably have a shape as an aggregate. The fluorescence layer is superior in heat-resisting property.

The first fluorescent substance of the light source device according to the present disclosure may be a sintered body of powder of raw materials for the first fluorescent substance. The light source device can therefore emit light at high brightness with a superior color rendering property.

The second fluorescent substance of the light source device according to the present disclosure may be a sintered. body of powder of raw materials for the second fluorescent substance. The light source device can therefore emit light at high brightness with a superior color rendering property.

The fluorescence layer of the light source device according to the present disclosure may include a first fluorescence layer and a second fluorescence layer. The first fluorescence layer includes first fluorescent substance. And the second fluorescence layer includes second fluorescent substance. The light source device can therefore emit light at high brightness with a superior color rendering property.

Exemplary embodiments of the present disclosure will be described below with reference to the drawings. The present disclosure is not limited to the following exemplary embodiments.

### First Exemplary Embodiment

As illustrated in FIG. 1, light source device 100 according to the present exemplary embodiment includes excitation light source 10 and wavelength conversion member 20. Excitation light source 10 is configured to emit excitation light. Excitation light source 10 is, for example, a laser diode (LD) or a light-emitting diode (LED). Excitation light source 10 is typically an LD. Excitation light source 10 may be constituted by a single LD, or may be constituted by a plurality of LDs. The plurality of LDs may be optically coupled.

Energy density of the excitation light emitted from excitation light source 10 is 10 W/mm² or more. It is more preferable that the energy density of the excitation. light be 100 W/mm² or more. An upper limit value of the energy density of the excitation light is not particularly limited. It is preferable that the energy density of the excitation light be 1000 W/mm² or less. It is more preferable that the energy density of the excitation light be 400 W/mm² or less. “Energy density” means a value calculated by dividing a value of irradiation energy of excitation light emitted to a certain region with a value of an area of the region. Energy density can be measured with a method described below, for example. Excitation light is emitted to a target. When irradiation intensity of the excitation light shows Gaussian distribution, a region where the irradiation intensity is 1/e or more of peak intensity is identified. Here, “e” indicates a natural logarithm. Irradiation energy of the excitation light emitted to the identified region is measured. An area of the identified region is measured. By dividing a value of the irradiation energy of the excitation light with a value of the area of the identified region, energy density is calculated.

It is preferable that a peak wavelength of excitation light from excitation light source 10 be 310 nm or more. It is more preferable that a peak wavelength of excitation light from excitation light source 10 be 350 nm or more. It is preferable that a peak wavelength of excitation light be 560 nm or less. It is more preferable that a peak wavelength of excitation light be 500 nm or less.

Wavelength conversion member 20 is a member configured to convert a wavelength of excitation light emitted from excitation light source 10. Wavelength conversion member 20 includes substrate 25 and fluorescence layer 30. FIG. 1 illustrates a cross-sectional view of wavelength conversion member 20. Substrate 25 has a plate shape, for example. Fluorescence layer 30 includes first fluorescence layer 31 or second fluorescence layer 32.

Fluorescence layer 30 is supported by substrate 25. Fluorescence layer 30 entirely covers a surface of substrate 25. Fluorescence layer 30 may partially cover the surface of substrate 25. Fluorescence layer 30 may be in contact with the surface of substrate 25.

Light source device 100 further includes incident optical system 15. Incident optical system 15 is disposed between excitation light source 10 and wavelength conversion member 20. Incident optical system 15 is configured to guide light emitted from excitation light source 10 to fluorescence layer 30 Incident optical system 15 includes a lens, a mirror, and an optical fiber, for example.

A material of substrate 25 is not particularly limited. The material of substrate 25 includes at least one selected from a group consisting of, for example, glass, silicon, quartz, silicon oxide, aluminum, sapphire, gallium nitride, aluminum nitride, and zinc oxide.

The surface of substrate 25 may be covered by a dielectric multi-layer, a reflective film, or an antireflective film, for example. The dielectric multi-layer and the reflective film are configured to reflect light at a certain wavelength, for example. The antireflective film is configured to prevent excitation light from being reflected, for example. A material of the dielectric multi-layer includes at least one selected from a group consisting of, for example, titanium oxide, zirconium oxide, tantalum oxide, cerium oxide, niobium oxide, tungsten oxide, silicon oxide, cesium fluoride, calcium fluoride, and magnesium fluoride. A material of the reflective film includes a metallic material, for example. The metallic material contains at least one selected from a group consisting of, for example, silver and aluminum. A material of the antireflective film contains at least one selected from a group consisting of, for example, titanium oxide, zirconium oxide, tantalum oxide, cerium oxide, niobium oxide, tungsten oxide, silicon oxide, cesium fluoride, calcium fluoride, and magnesium fluoride.

First fluorescence layer 31 includes first fluorescent substance 41 and first matrix 51. First fluorescent substance 41 receives excitation light from excitation light source 10 to emit fluorescence. A wavelength of the excitation light from excitation light source 10 is therefore converted. A peak wavelength of the fluorescence emitted by first fluorescent substance 41 ranges from 400 nm to 510 nm, inclusive. It is more preferable that the peak wavelength of the fluorescence emitted by first fluorescent substance 41 fall within a range from 420 nm to 480 nm, inclusive. First fluorescent substance 41 typically emit blue light. A value calculated by subtracting a value of a peak wavelength of the excitation light emitted from excitation light source 10 from a value of the peak wavelength of the fluorescence emitted by first fluorescent substance 41 may fall within a range from 20 nm to 200 nm, inclusive.

A fluorescence lifetime of first fluorescent substance 41 ranges from 0.1 nanoseconds (ns) to 250 ns, inclusive. The fluorescence lifetime of first fluorescent substance 41 may be 1.0 ns or more, or may be 10.0 ns or more. The fluorescence lifetime of first fluorescent substance 41 may be 100 ns or less. “Fluorescence lifetime” means a time required to return an excited state to a ground state for first fluorescent substance 41 that have absorbed excitation light and are thus have been excited. In other words, “fluorescence lifetime” means a time required to lower from a maximum value to lie of the maximum value for intensity of fluorescence emitted from first fluorescent substance 41. The fluorescence lifetime can be measured by using a commercially-available fluorescence lifetime measurement device.

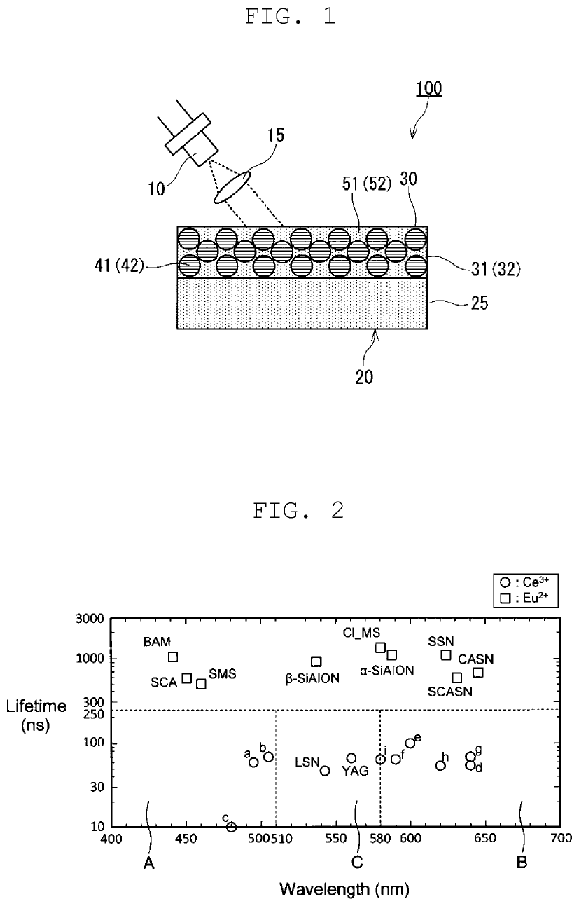

As illustrated in FIG. 2, first fluorescent substance 41 belong to range

A. A horizontal axis of a graph in FIG. 2 indicates a peak wavelength of fluorescence emitted from a fluorescent substance. A vertical axis of the graph in FIG. 2 indicates a fluorescence lifetime of the fluorescent substance. In the graph in FIG. 2, a circle mark indicates a fluorescent substance containing trivalent cerium as a light emission center. A square mark indicates a fluorescent substance containing divalent europium as a light emission center. First fluorescent substance 41 has the fluorescence lifetime shorter than a fluorescence lifetime of each of BaMgAl₁₀O₁₇:Eu²⁺(BAM:Eu), (Sr, Ca, Mg)₅(PO₄)₃Cl:Eu²⁺(SCA:Eu), and Sr₂MgSi₂O₇:Eu²⁺(SMS:Eu). BAM:Eu, SCA:Eu and SMS:Eu each emit blue light.

First fluorescent substance 41 include fluorescent substance containing trivalent cerium as a light emission center, for example. The fluorescent substance containing trivalent cerium includes at least one selected from a group consisting of, for example, a chemical compound represented by Lu₃(Ga₁₋ₓAlₓ)₅O₁₂:Ce³⁺ (0≤x≤1), a chemical compound represented by Y₃Sc₂(Ga_{1-y}Al_{y})₃O₁₂:Ce³⁺ (0≤y≤1), and a chemical compound. represented by (Ca_{1-z}RE_{z})₃(Zr_{1-w}Sc_{w})₂Sc₃O₁₂:Ce³⁺ (0≤z≤1, 0≤w≤1). RE includes at least one selected from a group consisting of Lu, Y, and Gd. The chemical compound represented by Lu₃(Ga₁₋ₓAlₓ)₅O₁₂:Ce³⁺ emits light having a peak wavelength falling within a range from 480 nm to 510 nm, inclusive, and has a fluorescence lifetime of 60 ns. The chemical compound represented by Y₃Sc₂(Ga_{1-y}Al_{y})₃O₁₂:Ce³⁺ emits light having a peak wavelength falling within a range from 500 nm to 510 nm, inclusive, and has a fluorescence lifetime ranging from 50 ns to 90 ns, inclusive. The chemical compound represented by (Ca_{1-z}RE_{z})₃(Zr_{1-w}Sc_{w})₂Sc₃O₁₂:Ce³⁺ emits light having a peak wavelength falling within a range from 470 nm to 490 nm , inclusive, and has a fluorescence lifetime ranging from 3 ns to 10 ns, inclusive. In the graph in FIG. 2, the chemical compound represented by Lu₃(Ga₁₋ₓAlₓ)₅O₁₂:Ce³⁺ is indicated by “a”. The chemical compound represented by Y₃Sc₂(Ga_{1-y}Al_{y})₃O₁₂:Ce³⁺ is indicated by “b”. The chemical compound represented by (Ca_{1-z}RE_{z})₃(Zr_{1-w}Sc_{w})₂Sc₃O₁₂:Ce³⁺ is indicated by “c”. First fluorescent substance 41 may be substantially made of the chemical compound represented by Lu₃(Ga₁₋ₓAlₓ)₅O₁₂:Ce³⁺. First fluorescent substance 41 may be substantially made of the chemical compound represented by Y₃Sc₂(Ga_{1-y}Al_{y})₃O₁₂:Ce³⁺. First fluorescent substance 41 may be substantially made of the chemical compound represented by (Ca_{1-z}RE_{z})₃(Zr_{1-w}Sc_{w})₂Sc₃O₁₂:Ce³⁺. “Substantially made of” in the present specification means that other components that affect essential characteristics of the mentioned chemical compound are eliminated.

A shape of first fluorescent substance 41 is not particularly limited. First fluorescent substance 41 has a particle shape, for example. An average particle diameter of first fluorescent substance 41 may fall within a range from 1 μm to 80 μm, inclusive. The “average particle diameter” can be measured with the following method. A surface or a cross-section of first fluorescence layer 31 is observed with an electronic microscope to measure a diameter of each of a predetermined number of particles (e.g., 50) contained in first fluorescence layer 31. The average particle diameter is determined based on an average value calculated using the obtained measured values. A diameter of a circle having an area equal to an area of each of the particles observed with the electronic microscope can be regarded as the particle diameter. The particle shape is not particularly limited. The particle shape may include various shape such as a spherical shape, a scale shape, and a fibrous shape.

First matrix 51 surrounds first fluorescent substance 41. First matrix 51 may entirely cover a surface of each of the particles of first fluorescent substance 41, or may partially cover the surface of each of the particles. First matrix 51 contains at least one selected from a group consisting of, for example, resin, glass, transparent crystal, and inorganic material. The inorganic material contains at least one selected from a group consisting of, for example, ZnO, SiO₂, and TiO₂. First matrix 51 may be substantially made of ZnO. First fluorescence layer 31 may not include first matrix 51. A ratio of a weight of first fluorescent substance 41 with respect to a weight of first matrix 51 may fall within a range from 0.03 to 0.7, inclusive. With first matrix 51 surrounding first fluorescent substance 41, first fluorescent substance 41 stably has a shape as an aggregate. In a case where a material of first matrix 51 is superior in heat-resisting property, fluorescence layer 30 is superior in heat-resisting property.

First fluorescence layer 31 may further contain fillers. The fillers each have high thermal conductivity, for example. In a case where first fluorescence layer 31 contains the fillers, first fluorescence layer 31 is superior in heat-resisting property. A material of each of the fillers includes an inorganic material, for example. As the inorganic material, one of the materials described above can be used. The fillers each have a particle shape, for example. An average particle diameter of each of the fillers is smaller than the average particle diameter of first fluorescent substance 41, for example. The average particle diameter of each of the fillers may fall within a range from 0.1 μm to 20 μm, inclusive.

Second fluorescence layer 32 includes second fluorescent substance 42 and second matrix 52. Second fluorescent substance 42 each receive excitation light from excitation light source 10 to emit fluorescence. A wavelength of the excitation light from excitation light source 10 is therefore converted. A peak wavelength of the fluorescence emitted by second fluorescent substance 42 ranges from 580 nm to 700 nm, inclusive. It is more preferable that the peak wavelength of the fluorescence emitted by each of second fluorescent substance 42 fall within a range from 590 nm to 650 nm, inclusive. Second fluorescent substance 42 typically emit red light. A value calculated by subtracting a value of the peak wavelength of the excitation light emitted from excitation light source 10 from a value of the peak wavelength of the fluorescence emitted by second fluorescent substance 42 may fall within a range from 20 nm to 350 nm, inclusive.

A fluorescence lifetime of each of second fluorescent substance 42 ranges from 0.1 ns to 250 ns, inclusive. The fluorescence lifetime of second fluorescent substance 42 may be 1.0 ns or more, or may be 10.0 ns or more. The fluorescence lifetime of each of second fluorescent substance 42 may be 100 ns or less.

As illustrated in FIG. 2, second fluorescent substance 42 belong to range B. Second fluorescent substance 42 has the fluorescence lifetime shorter than a fluorescence lifetime of each of CaAlSiN₃:Eu²⁺(CASN:Eu) and (Sr, Ca)AlSiN₃:Eu²⁺(SCASN:Eu). CASN:Eu and SCASN:Eu each emit red light.

Second fluorescent substance 42 include fluorescent substance containing trivalent cerium as a light emission center, for example. The fluorescent substance containing trivalent cerium includes at least one selected from a group consisting of, for example, a chemical compound represented by La₃(Si₆₋ₛ, Alₛ)N_{11-(1/3)s}:Ce³⁺ (0≤s≤1), a chemical compound represented by Lu₂CaMg₂Si₃O₁₂:Ce³⁺, a chemical compound represented by (Ca, Sr, Ba, Mg)AlSiN₃:Ce³⁺, a chemical compound represented by CaSiN₂:Ce³⁺, a chemical compound represented by Sr₃Sc₄O₉:Ce³⁺, and a chemical compound represented by GdSr₂AlO₅:Ce³⁺. The chemical compound represented by La₃(Si₆₋ₛ, Alₛ)N_{11-(1/3)s}:Ce³⁺ emits light having a peak wavelength of 640 nm, and has a fluorescence lifetime of 55 ns. The chemical compound represented by Lu₂CaMg₂Si₃O₁₂:Ce³⁺ emits light having a peak wavelength of 600 nm, and has a fluorescence lifetime of 100 ns. The chemical compound represented by (Ca, Sr, Ba, Mg)AlSiN₃:Ce³⁺ emits light having a peak wavelength of 590 nm, and has a fluorescence lifetime ranging from 60 ns to 70 ns, inclusive. The chemical compound represented by CaSiN₂:Ce³⁺ emits light having a peak wavelength of 640 nm, and has a fluorescence lifetime of 70 ns. The chemical compound represented by Sr₃Sc₄O₉:Ce³⁺ emits light having a peak wavelength of 620 nm, and has a fluorescence lifetime of 55 ns. The chemical compound represented by GdSr₂AlO₅:Ce³⁺ emits light having a peak wavelength of 580 nm, and has a fluorescence lifetime of 65 ns. In the graph in FIG. 2, the chemical compound represented by La₃(Si₆₋ₛ, Alₛ)N_{11-1/3)s}:Ce³⁺ is indicated by “d”. The chemical compound represented by Lu₂CaMg₂Si₃O₁₂:Ce³⁺ is indicated by “e”. The chemical compound represented by (Ca, Sr, Ba, Mg)AlSiN₃:Ce³⁺ is indicated by “f”. The chemical compound represented by CaSiN₂:Ce³⁺ is indicated by “g”. The chemical compound represented by Sr₃Sc₄O₉:Ce³⁺ is indicated by “h”. The chemical compound represented by GdSr₂AlO₅:Ce³⁺ is indicated by “i”. Second fluorescent substance 42 may each be substantially made of the chemical compound represented by La₃(Si₆₋ₛ, Alₛ)N_{11(1/3)s}:Ce³⁺. Second fluorescent substance 42 may be substantially made of the chemical compound represented by Lu₂CaMg₂Si₃O₁₂:Ce³⁺. Second fluorescent substance 42 may be substantially made of the chemical compound represented by (Ca, Sr, Ba, Mg)AlSiN₃:Ce³⁺. Second fluorescent substance 42 may be substantially made of the chemical compound represented by CaSiN₂:Ce³⁺. Second fluorescent substance 42 may be substantially made of the chemical compound represented by Sr₃Sc₄O₉:Ce³⁺. Second fluorescent substance 42 may be substantially made of the chemical compound represented by GdSr₂AlO₅:Ce³⁺.

In the present specification, when a plurality of elements each separated by a comma (,) are included in a composition formula, it is meant that the composition formula contains at least one element selected from the plurality of elements included in the chemical compound. For example, the composition formula “(Ca, Sr, Ba, Mg)AlSiN₃:Ce³⁺” is comprehensively indicative of all of “CaAlSiN₃:Ce³⁺”, “SrAlSiN₃:Ce³⁺”, “BaAlSiN₃:Ce³⁺”, “MgAlSiN₃:Ce³⁺”, “Ca₁₋ₘSrₘAlSiN₃:Ce³⁺”, “Ca₁₋ₘBaₘAlSiN₃:Ce³⁺”, “Ca₁₋ₘMgₘAlSiN₃:Ce³⁺”, “Sr₁₋ₘBaₘAlSiN₃:Ce³⁺”, “Sr₁₋ₘMgₘAlSiN₃:Ce³⁺”, “Ba₁₋ₘMgₘAlSiN₃:Ce³⁺”, “Ca₁₋ₘ₋ₙSrₘBaₙAlSiN₃:Ce³⁺”, “Ca₁₋ₘ₋ₙSrₘMgₙAlSiN₃:Ce³⁺”, “Ca₁₋ₘ₋ₙBaₘMgₙAlSiN₃:Ce³⁺”, “Sr₁₋ₘ₋ₙBaₘMgₙAlSiN₃:Ce³⁺”, and “Ca₁₋ₘ₋ₙ₋ₚSrₘBaₙMgₚAlSiN₃:Ce³⁺”. As for m, n, and p, 0<m<1, 0<n<1, 0<p<1, 0<m+n<1, and 0<m+n+p<1 are respectively satisfied.

A shape of second fluorescent substance 42 is not particularly limited. Second fluorescent substance 42 has a particle shape, for example. An average particle diameter of second fluorescent substance 42 may fall within a range from 1 μm to 80 μm, inclusive.

Second matrix 52 surrounds second fluorescent substance 42. Second matrix 52 may entirely cover a surface of each of the particles of second fluorescent substance 42, or may partially cover the surface of each of the particles. Second matrix 52 contains at least one selected from a group consisting of, for example, resin, glass, transparent crystal, and inorganic material. As the inorganic material, one of the materials described above can be used. Second matrix 52 may be substantially made of ZnO. Second fluorescence layer 32 may not include second matrix 52. A ratio of a weight of second fluorescent substance 42 with respect to a weight of second matrix 52 may fall within a range from 0.03 to 0.7, inclusive. With second matrix 52 surrounding second fluorescent substance 42, second fluorescent substance 42 stably has a shape as an aggregate. In a case where a material of second matrix 52 is superior in heat-resisting property, fluorescence layer 30 is superior in heat-resisting property.

Second fluorescence layer 32 may further contain fillers. The fillers may be identical to the fillers contained in first fluorescence layer 31, as exemplified above.

Next, a method for manufacturing wavelength conversion member 20 will be described.

First, first fluorescent substance 41 are produced. A method for producing first fluorescent substance 41 is not particularly limited. Any known method can be utilized. For example, powder of raw materials of first fluorescent substance 41 is mixed. In a case where first fluorescent substance 41 contains Lu₃(Ga₁₋ₓAlₓ)₅O₁₂:Ce³⁺, for example, powder of a chemical compound containing Ce, powder of a chemical compound containing Lu, powder of a chemical compound containing Ga, and powder of a chemical compound containing Al are mixed. The powder can be mixed by using a ball mill, for example. The powder of the raw materials which have been mixed is sintered. Sintering conditions are not particularly limited. Sintering may be performed by using an electric furnace. Sintering may be performed under a nitrogen atmosphere. A sintering temperature may fall within a range from 1500° C. to 2000° C., inclusive. Sintering may be performed for a period ranging from 1 hour to 50 hours, inclusive, for example. Pressure inside the electric furnace may be three atmospheric pressure or more. In this way, first fluorescent substance 41 is obtained as a sintered body of the powder of the raw materials of first fluorescent substance 41. First fluorescent substance 41 being obtained may be cleaned with a cleaning liquid. The cleaning liquid is, for example, a nitric acid solution. First fluorescent substance 41 being obtained may be grinded to adjust the average particle diameter of first fluorescent substance 41. First fluorescent substance 41 may be grinded by using a grinder such as a ball mill or a jet mill.

Next, first fluorescence layer 31 is disposed on substrate 25. The present exemplary embodiment describes a case where first matrix 51 is made of zinc oxide. First, a thin film of zinc oxide is formed on substrate 25. As a method for forming the thin film of zinc oxide, a gas phase film forming method such as electron-beam evaporation, plasma deposition, sputtering, or pulse laser deposition can be used.

Next, particles of first fluorescent substance 41 are disposed on the thin film of zinc oxide. A method for disposing the particles of first fluorescent substance 41 on the thin film of zinc oxide is not particularly limited. For example, a dispersion liquid in which the particles of first fluorescent substance 41 are dispersed is formed. Next, substrate 25 is placed in the dispersion liquid. Electrophoresis can be utilized to dispose first fluorescent substance 41 on the thin film of zinc oxide. First fluorescent substance 41 may be disposed on the thin film of zinc oxide by letting first fluorescent substance 41 in a dispersion liquid settle on the thin film of zinc oxide. A paste in which first fluorescent substance 41 are dispersed may be applied on the thin film of zinc oxide to dispose first fluorescent substance 41 on the thin film of zinc oxide.

Next, with a liquid phase growth method, first matrix 51 can be formed from the thin film of zinc oxide. By this method, first fluorescence layer 31 is formed. The liquid phase growth method may be chemical bath deposition, hydrothermal synthesis, or electrochemical deposition, for example. An example of a solution for crystal growth includes a water solution containing hexamethylenetetramine and zinc nitrate.

As a method for producing second fluorescent substance 42, the method exemplified as the method for producing first fluorescent substance 41 can be used. For example, powder of raw materials of second fluorescent substance 42 is mixed. The powder of the raw materials which have been mixed is sintered. In this way, second fluorescent substance 42 is obtained as a sintered body of the powder of the raw materials of second fluorescent substance 42. Second fluorescent substance 42 being obtained may be cleaned with a cleaning liquid. Second fluorescent substance 42 being obtained may be grinded to adjust the average particle diameter of second fluorescent substance 42.

As a method for disposing second fluorescence layer 32 on substrate 25, the method exemplified as the method for disposing first fluorescence layer 31 on substrate 25 can be used.

Next, operation of light source device 100 will be described herein.

First, excitation light source 10 emits excitation light. The excitation light passes through incident optical system 15, and enters first fluorescence layer 31 or second fluorescence layer 32 of wavelength conversion member 20. First fluorescent substance 41 included in first fluorescence layer 31 receives the excitation light to emit fluorescence. Second fluorescent substance 42 included in second fluorescence layer 32 receives the excitation light to emit fluorescence. In this way, light is emitted from light source device 100. The light emitted from light source device 100 may include some of the excitation light from excitation light source 10.

In FIG. 1, excitation light source 10 emits light to first fluorescence layer 31 or second fluorescence layer 32 of wavelength conversion member 20. Alternatively, excitation light source 10 may emit light to substrate 25 of wavelength conversion member 20. In this case, substrate 25 is made of a material that allows excitation light from excitation light source 10 to pass through.

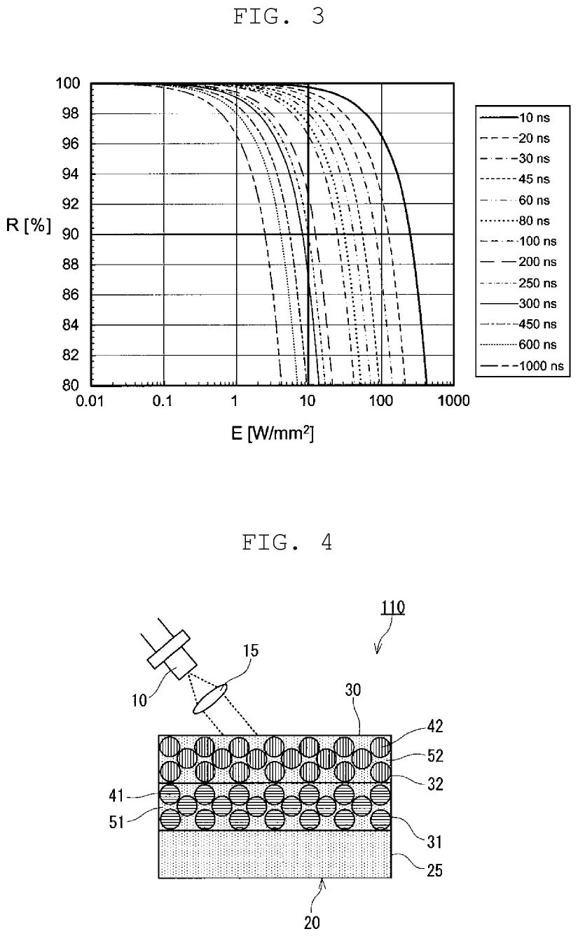

In light source device 100 according to the present exemplary embodiment, the respective fluorescence lifetimes of first fluorescent substance 41 and second fluorescent substance 42 are relatively shorter. As shown in FIG. 3, as a fluorescence lifetime of a fluorescent substance become shorter, a maintenance factor of internal quantum efficiency of the fluorescent substance increases. A horizontal axis of a graph in FIG. 3 indicates energy density E of excitation light (W/mm²). A vertical axis of the graph in FIG. 3 indicates maintenance factor R (%) of internal quantum efficiency of a fluorescent substance. Internal quantum efficiency of a fluorescent substance means a ratio of a number of photons in light emitted from the fluorescent substance with respect to a number of photons in excitation light absorbed by the fluorescent substance. Maintenance factor R of internal quantum efficiency of a fluorescent substance is represented by Equation (1) described below.

R (%)=η(E)/η(0.01)×100 (1)

In Equation (1), internal quantum efficiency of a fluorescent substance when the fluorescent substance is irradiated with excitation light having an energy density of E (W/mm²) is indicated by η (E). Internal quantum efficiency of a fluorescent substance when the fluorescent substance is irradiated with excitation light having an energy density of 0.01 W/mm² is indicated by η (0.01). When maintenance factor R of internal quantum efficiency of a fluorescent substance is higher, the fluorescent substance can emit light at high intensity.

The graph in FIG. 3 illustrates results of simulations. For example, numerical analysis software can be used. to perform such simulations. Specifically, as analysis targets, six-level models are used. The six-level models are created based on configuration coordinate models that respectively have been taken into account general four levels representing absorption and emission of light and a level of a conductor. In the six-level models, re-excitation is taken into account. Re-excitation means that a fluorescent substance in an excitation state absorbs light. A fluorescence lifetime corresponds to an inverse number of a transition rate from an excitation level to a light emission level. By mathematically modelling an analysis target, a fundamental equation (rate equation) can be obtained as a time evolution problem between carrier density and light density. By designating a time change amount in the fundamental equation to 0, an algebraic equation can be obtained. By calculating the algebraic equation being obtained with numerical analysis software, the graph in FIG. 3 can be obtained. As numerical analysis software, Mathematica can be used, for example. Mathematica can solve a nonlinear algebraic equation.

As illustrated in FIG. 3, as long as a fluorescence lifetime of a fluorescent substance is 250 ns or less, maintenance factor R of 90% or more can be achieved, even when excitation light has energy density E of 10 W/mm². Since the fluorescence lifetime of each of first fluorescent substance 41 and second fluorescent substance 42 is 250 ns or less, first fluorescent substance 41 and second fluorescent substance 42 respectively can emit light at high intensity. That is, light source device 100 can emit light at high brightness.

### Second Exemplary Embodiment

As illustrated in FIG. 4, in light source device 110 according to the present exemplary embodiment, fluorescence layer 30 includes both first fluorescence layer 31 and second fluorescence layer 32. Light source device 110 is identical in structure to light source device 100 according to the first exemplary embodiment except that fluorescence layer 30 includes both first fluorescence layer 31 and second fluorescence layer 32. Thus, constituent elements which are common between light source device 100 according to the first exemplary embodiment and light source device 110 according to the present exemplary embodiment are denoted by the same reference marks and may not be described in detail below. That is, the descriptions regarding the following exemplary embodiments are mutually applicable, in so far as they are technically consistent with one another. In addition, the respective exemplary embodiments may be combined with one another, in so far as they are technically consistent with one another.

In FIG. 4, first fluorescence layer 31 is supported by substrate 25. Second fluorescence layer 32 is disposed on first fluorescence layer 31. That is, in a thickness direction of substrate 25, substrate 25, first fluorescence layer 31, and second fluorescence layer 32 are arranged in this order.

Alternatively, first fluorescence layer 31 and second fluorescence layer 32 may be respectively switched in position from each other. First fluorescence layer 31 may be in contact with second fluorescence layer 32.

A ratio of a fluorescence lifetime of first fluorescent substance 41 with respect to a fluorescence lifetime of second fluorescent substance 42 may fall within a range from 0.5 to 2.0, inclusive. In this case, even when energy density of excitation light is high, a maintenance factor of internal quantum efficiency of first fluorescent substance 41 is substantially identical to a maintenance factor of internal quantum efficiency of second fluorescent substance 42. Hence, light source device 110 can emit light at high brightness with a superior color rendering property.

As a method for disposing second fluorescence layer 32 on first fluorescence layer 31, the method exemplified in the first exemplary embodiment as the method for disposing first fluorescence layer 31 on substrate 25 can be used, for example. By disposing second fluorescence layer 32 on first fluorescence layer 31 after first fluorescence layer 31 is disposed on substrate 25, wavelength conversion member 20 can be obtained.

When excitation light is emitted from excitation light source 10, the excitation light passes through incident optical system 15, and enters second fluorescence layer 32 of wavelength conversion member 20. Second fluorescent substance 42 included in second fluorescence layer 32 receives the excitation light to emit fluorescence. Some of the excitation light, which was not absorbed by second fluorescence layer 32, enters first fluorescence layer 31. First fluorescent substance 41 included in first fluorescence layer 31 receives the some of the excitation light to emit fluorescence. In this way, light is emitted from light source device 110. The light emitted from light source device 110 may include some of excitation light from excitation light source 10.

Since the fluorescence lifetime of each of first fluorescent substance 41 and second fluorescent substance 42 is 250 ns or less, first fluorescent substance 41 and second fluorescent substance 42 respectively can emit light at high intensity. That is, light source device 110 can emit light at high brightness. Since a difference between the maintenance factor of internal quantum efficiency of first fluorescent substance 41 and the maintenance factor of internal quantum efficiency of second fluorescent substance 42 is small, light with a superior color rendering property can be obtained from light source device 110.

### Third Exemplary Embodiment

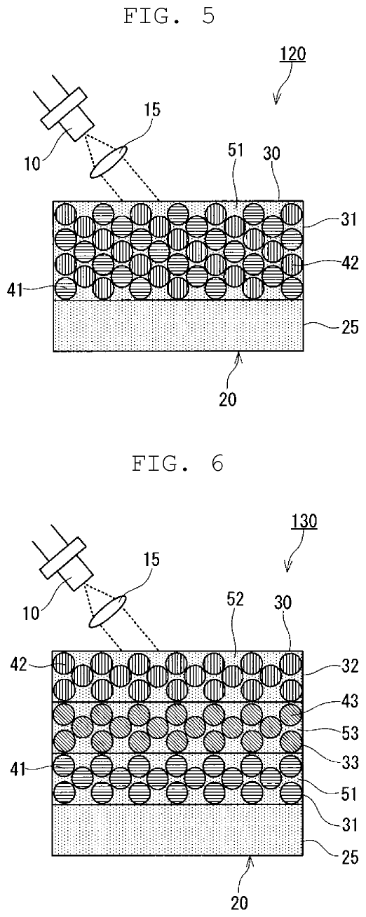

As illustrated in FIG. 5, first fluorescence layer 31 of light source device 120 according to the present exemplary embodiment includes first fluorescent substance 41 and second fluorescent substance 42. Light source device 120 is identical in structure to light source device 100 according to the first exemplary embodiment except that first fluorescence layer 31 further includes second fluorescent substance 42.

A weight ratio between first fluorescent substance 41 and second fluorescent substance 42 is determined in accordance with, for example, a target color tone and intensity of light to be emitted from each fluorescent substance.

When excitation light is emitted from excitation light source 10, the excitation light passes through incident optical system 15, and enters first fluorescence layer 31 of wavelength conversion member 20. First fluorescent substance 41 receives the excitation light to emit fluorescence. Second fluorescent substance 42 receives the excitation light to emit fluorescence. In this way, light is emitted from light source device 120. The light emitted from light source device 120 may include some of the excitation light from excitation light source 10.

Since a fluorescence lifetime of each of first fluorescent substance 41 and second fluorescent substance 42 is 250 ns or less, first fluorescent substance 41 and second fluorescent substance 42 respectively can emit light at high intensity. That is, light source device 120 can emit light at high brightness. Since a difference between a maintenance factor of internal quantum efficiency of first fluorescent substance 41 and a maintenance factor of internal quantum efficiency of second fluorescent substance 42 is small, light with a superior color rendering property can be obtained from light source device 120.

### Fourth Exemplary Embodiment

As illustrated in FIG. 6, in light source device 130 according to the present exemplary embodiment, fluorescence layer 30 includes first fluorescence layer 31, second fluorescence layer 32, and third fluorescence layer 33. Third fluorescence layer 33 is disposed between first fluorescence layer 31 and second fluorescence layer 32. That is, in the thickness direction of substrate 25, substrate 25, first fluorescence layer 31, third fluorescence layer 33, and second fluorescence layer 32 are arranged in this order.

Alternatively, first fluorescence layer 31, second fluorescence layer 32, and third fluorescence layer 33 may be respectively switched in position from each other. Third fluorescence layer 33 may be in contact with each of first fluorescence layer 31 and second fluorescence layer 32.

Third fluorescence layer 33 includes third fluorescent substance 43 and third matrix 53. Third fluorescent substance 43 receives excitation light from excitation light source 10 to emit fluorescence. A peak wavelength of the fluorescence emitted by third fluorescent substance 43 is greater than 510 nm. The peak wavelength of the fluorescence emitted by third fluorescent substance 43 is smaller than 580 nm. Third fluorescent substance 43 typically emit green light or yellow light.

A fluorescence lifetime of third fluorescent substance 43 ranges from 0.1 ns to 250 ns, inclusive. The fluorescence lifetime of third fluorescent substance 43 may be 1.0 ns or more, or may be 10.0 ns or more. The fluorescence lifetime of third fluorescent substance 43 may be 100 ns or less. A ratio of the fluorescence lifetime of third fluorescent substance 43 with respect to a fluorescence lifetime of first fluorescent substance 41 may fall within a range from 0.5 to 2.0, inclusive. A ratio of the fluorescence lifetime of third fluorescent substance 43 with respect to a fluorescence lifetime of second. fluorescent substance 42 may fall within a range from 0.5 to 2.0, inclusive. At this case, even when energy density of excitation light is high, a difference between a maintenance factor of internal quantum efficiency of third fluorescent substance 43 and a maintenance factor of internal quantum efficiency of each of first fluorescent substance 41 and second fluorescent substance 42 is small. Thus, light source device 130 can emit light at high brightness with a superior color rendering property.

As illustrated in FIG. 2, third fluorescent substance 43 belong to range C. Third fluorescent substance 43 has the fluorescence lifetime shorter than a fluorescence lifetime of Si₆₋ᵤAlᵤOᵤN₈₋ᵤ:Eu²⁺(β-SiAlON:Eu). At this time, u satisfies 0<u<4.2. β-SiAlON:Eu emits green light.

Third fluorescent substance 43 include fluorescent substance containing trivalent cerium as a light emission center, for example. A fluorescent substance containing trivalent cerium includes at least one selected from a group consisting of, for example, a chemical compound represented by La₃Si₆N₁₁:Ce³⁺ (LSN:Ce) and a chemical compound represented by Y₃Al₅O₁₂:Ce³⁺ (YAG:Ce). LSN:Ce emits light having a peak wavelength of 540 nm, and has a fluorescence lifetime of 50 ns. YAG:Ce emits light having a peak wavelength of 560 nm, and has a fluorescence lifetime of 60 ns. Third fluorescent substance 43 may be substantially made of LSN:Ce. Third fluorescent substance 43 may be substantially made of YAG:Ce.

A shape of third fluorescent substance 43 is not particularly limited. Third fluorescent substance 43 has a particle shape, for example. An average particle diameter of third fluorescent substance 43 may fall within a range from 1 μm to 80 μm, inclusive.

Third matrix 53 surrounds third fluorescent substance 43. Third matrix 53 may entirely cover a surface of each of the particles of third fluorescent substance 43, or may partially cover the surface of each of the particles. Third matrix 53 contains at least one selected from a group consisting of, for example, resin, glass, transparent crystal, and inorganic material. As the inorganic material, one of the materials described above can be used. Third matrix 53 may be substantially made of ZnO. Third fluorescence layer 33 may not include third matrix 53. A ratio of a weight of third fluorescent substance 43 with respect to a weight of third matrix 53 may fall within a range from 0.03 to 0.7, inclusive. With third matrix 53 surrounding third fluorescent substance 43, third fluorescent substance 43 stably has a shape as an aggregate. In a case where a material of third matrix 53 is superior in heat-resisting property, fluorescence layer 30 is superior in heat-resisting property.

Third fluorescence layer 33 may further contain fillers. The fillers may be identical to the fillers contained in first fluorescence layer 31, as exemplified above.

As a method for producing third fluorescent substance 43, the method exemplified as the method for producing first fluorescent substance 41 can be used. For example, powder of raw materials of third fluorescent substance 43 is mixed. The powder of the raw materials which have been mixed is sintered. In this way, third fluorescent substance 43 is obtained as a sintered body of the powder of the raw materials of third. fluorescent substance 43. Third fluorescent substance 43 being obtained may be cleaned with a cleaning liquid. Third fluorescent substance 43 being obtained may be grinded to adjust the average particle diameter of third fluorescent substance 43.

As a method for disposing third fluorescence layer 33 on first fluorescence layer 31, the method exemplified in the first exemplary embodiment as the method for disposing first fluorescence layer 31 on substrate 25 can be used, for example. Third fluorescence layer 33 is disposed on first fluorescence layer 31 after first fluorescence layer 31 is disposed on substrate 25. By further disposing second fluorescence layer 32 on third fluorescence layer 33, wavelength conversion member 20 can be obtained.

When excitation light is emitted from excitation light source 10, the excitation light passes through incident optical system 15, and enters second fluorescence layer 32 of wavelength conversion member 20. Second fluorescent substance 42 included in second fluorescence layer 32 receives the excitation light to emit fluorescence. Some of the excitation light, which was not absorbed by second fluorescence layer 32, enters third fluorescence layer 33. Third fluorescent substance 43 included in third fluorescence layer 33 receives the some of the excitation light to emit fluorescence. Some of the excitation light, which was not absorbed by third fluorescence layer 33, enters first fluorescence layer 31. First fluorescent substance 41 included in first fluorescence layer 31 receives the some of the excitation light to emit fluorescence. Second fluorescent substance 42 emit red light. Third fluorescent substance 43 emit green light or yellow light. First fluorescent substance 41 emit blue light. When the lights mix with each other, white light is obtained. Hence, white light is emitted from light source device 130. The light emitted from light source device 130 may include some of excitation light from excitation light source 10.

Since the fluorescence lifetime of each of first fluorescent substance 41, second fluorescent substance 42, and third fluorescent substance 43 is 250 ns or less, first fluorescent substance 41, second fluorescent substance 42, and third fluorescent substance 43 can each emit light at high intensity. That is, light source device 130 can emit light at high brightness. Since the maintenance factors of internal quantum efficiency of first fluorescent substance 41, second fluorescent substance 42, and third fluorescent substance 43 are respectively substantially identical to each other, light source device 130 can emit light with a superior color rendering property. That is, light source device 130 can emit light at high brightness with a superior color rendering property.

Depending on a target color tone, fluorescence layer 30 of light source device 130 may not include first fluorescence layer 31, but may include second fluorescence layer 32 and third fluorescence layer 33. Fluorescence layer 30 of light source device 130 may not include second fluorescence layer 32, but may include first fluorescence layer 31 and third fluorescence layer 33.

### Fifth Exemplary Embodiment

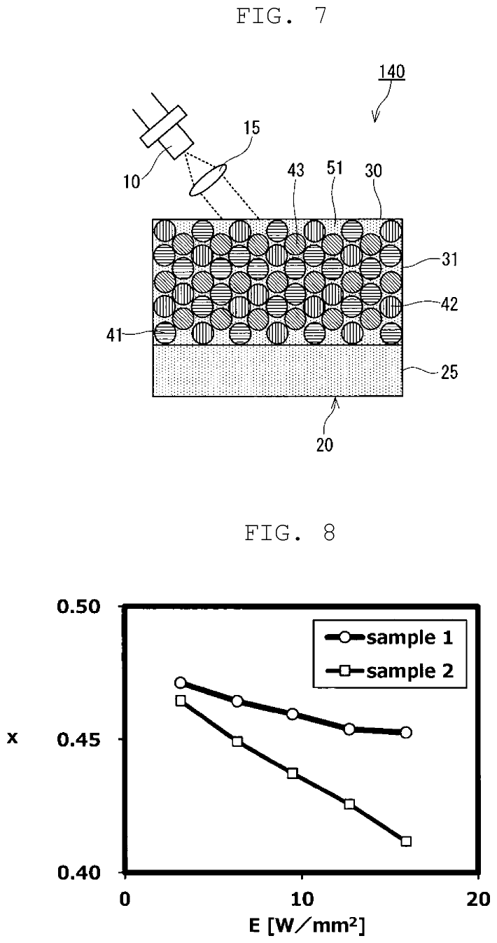

As illustrated in FIG. 7, first fluorescence layer 31 of light source device 140 according to the present exemplary embodiment includes first fluorescent substance 41, second fluorescent substance 42, and third fluorescent substance 43. Light source device 140 is identical in structure to light source device 100 according to the first exemplary embodiment except that first fluorescence layer 31 further includes second fluorescent substance 42 and third fluorescent substance 43.

A weight ratio among first fluorescent substance 41, second fluorescent substance 42, and third fluorescent substance 43 is determined in accordance with, for example, a target color tone and intensity of light to be emitted from each fluorescent substance.

When excitation light is emitted from excitation light source 10, the excitation light passes through incident optical system 15, and enters first fluorescence layer 31 of wavelength conversion member 20. First fluorescent substance 41 receives the excitation light to emit blue light. Second fluorescent substance 42 receives the excitation light to emit red light. Third fluorescent substance 43 receives the excitation light to emit green light or yellow light. When the lights mix with each other, white light is obtained. Hence, white light is emitted from light source device 140. The light emitted. from light source device 140 may include some of excitation light from excitation light source 10.

Since a fluorescence lifetime of each of first fluorescent substance 41, second fluorescent substance 42, and third fluorescent substance 43 is 250 ns or less, first fluorescent substance 41, second fluorescent substance 42, and third fluorescent substance 43 can each emit light at high intensity. That is, light source device 140 can emit light at high brightness. Since maintenance factors of internal quantum efficiency of first fluorescent substance 41, second fluorescent substance 42, and third fluorescent substance 43 are respectively substantially identical to each other, light source device 140 can emit light with a superior color rendering property. That is, light source device 140 can emit light at high brightness with a superior color rendering property.

Depending on a target color tone, first fluorescence layer 31 of light source device 140 may not include first fluorescent substance 41, but may include second fluorescent substance 42, third fluorescent substance 43, and first matrix 51. First fluorescence layer 31 of light source device 140 may not include second fluorescent substance 42, but may include first fluorescent substance 41, third fluorescent substance 43, and first matrix 51.

### EXAMPLES

The present disclosure will be specifically described with reference to examples. However, the present disclosure is not limited to the examples described below.

### (Sample 1)

First, a thin film of zinc oxide was formed on a substrate. The substrate was made of sapphire. Particles of fluorescent substance were disposed on the thin film of zinc oxide. As the fluorescent substance, Lu₂CaMg₂Si₃O₁₂:Ce³⁺ and YAG:Ce were used. A ratio of a weight of Lu₂CaMg₂Si₃O₁₂:Ce³⁺ with respect to a weight of YAG:Ce was 0.33. A fluorescence lifetime of Lu₂CaMg₂Si₃O₁₂:Ce³⁺ was 100 ns. A fluorescence lifetime of YAG:Ce was 60 ns. Next, a liquid phase growth method was used to form a matrix. The matrix was made of zinc oxide. A ratio of a volume of the fluorescent substance with respect to a volume of the matrix was 1.0. As described above, a wavelength conversion member serving as Sample 1 was obtained.

### (Sample 2)

A wavelength conversion member serving as Sample 2 was obtained with the identical method for producing Sample 1 except that, as fluorescent substance, SCASN:Eu was used instead of Lu₂CaMg₂Si₃O₁₂Ce³⁺. A fluorescence lifetime of SCASN:Eu was 400 ns.

### (Measuring CIE Chromaticity Coordinate)

When the wavelength conversion members serving as Samples 1 and 2 were respectively irradiated with excitation light, light was emitted from each. of the wavelength conversion members serving as Samples 1 and 2. For the light emitted from each of the wavelength conversion members serving as Samples 1 and 2, a CIE chromaticity coordinate was measured. At this time, a blue laser diode was used as an excitation light source. Energy density E of excitation light was 3.2 W/mm². A peak wavelength of the excitation light was 445 nm. A spectrophotometer (MCPD-9800 manufactured by Otsuka Electronics Co., Ltd.) was used to measure CIE chromaticity coordinates.

Next, energy density E of the excitation light was changed to 6.4 Wi/m², 9.5 W/mm², 12.7 W/mm², and 15.9 W/mm². At this time, for the light emitted from each of the wavelength conversion members serving as Samples 1 and 2, a CIE chromaticity coordinate was measured. Tables 1 and 2 show the obtained results. Table 1 shows a relationship between energy density E of the excitation light and an x value of the CIE chromaticity coordinate being obtained. Table 2 shows a relationship between energy density E of the excitation light and a y value of the CIE chromaticity coordinate being obtained.

TABLE 1

| Energy density E of | |
|---|---|
| excitation light | x value of chromaticity coordinate |

| [W/mm²] | Sample 1 | Sample 2 |
|---|---|---|
| 3.2 | 0.4713 | 0.4646 |
| 6.4 | 0.4644 | 0.4492 |
| 9.5 | 0.4596 | 0.4373 |
| 12.7 | 0.4540 | 0.4257 |
| 15.9 | 0.4527 | 0.4118 |

TABLE 2

| | |
|---|---|
| Energy density e of | |
| excitation light | y value of chromaticity coordinate |

| [W/mm²] | Sample 1 | Sample 2 |
|---|---|---|
| 3.2 | 0.4111 | 0.4067 |
| 6.4 | 0.4031 | 0.4017 |
| 9.5 | 0.3963 | 0.3932 |
| 12.7 | 0.3880 | 0.3813 |
| 15.9 | 0.3853 | 0.3622 |

FIG. 8 is a graph showing the measurement values in Table 1. FIG. 9 is a graph showing the measurement values in Table 2. As can be seen from FIGS. 8 and 9, as energy density E of the excitation light increased, each of the x value and the y value in the chromaticity coordinate of the light emitted from the wavelength conversion member serving as Sample 2 reduced. On the other hand, as for the light emitted from the wavelength conversion member serving as Sample 1, reduction in each of the x value and the y value in the chromaticity coordinate were suppressed.

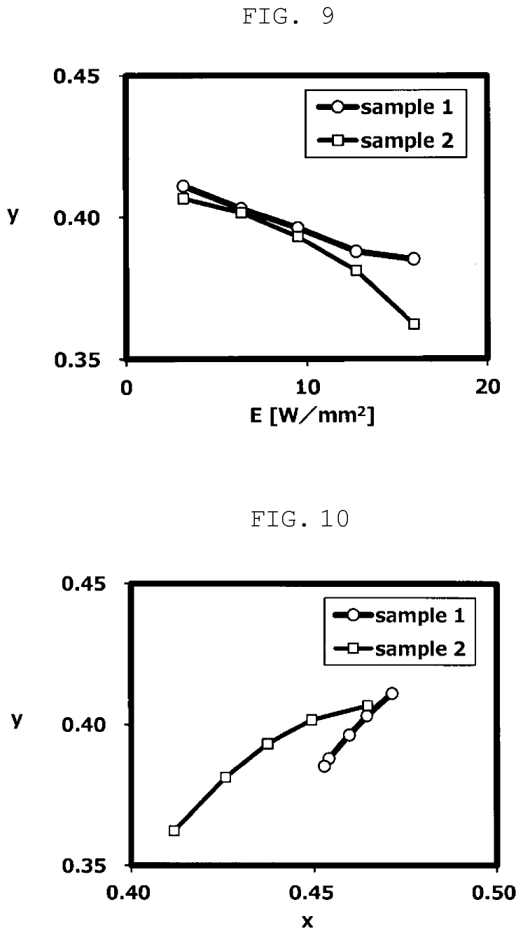

As can be seen from FIG. 10, the chromaticity coordinate of the light emitted from the wavelength conversion member serving as Sample 1 was smaller in change than the chromaticity coordinate of the light emitted from the wavelength conversion member serving as Sample 2. A graph in FIG. 10 shows a relationship between the x value of the chromaticity coordinate in Table 1 and the y value of the chromaticity coordinate in Table 2.

As described above, in Sample 1, even when energy density E of the excitation light was high, the chromaticity coordinate of the light emitted from the wavelength conversion member did not substantially change. This is due to that, in Sample 1, the respective fluorescence lifetimes of Lu₂CaMg₂Si₃O₁₂:Ce³⁺ and YAG:Ce were short. That is, this is due to that, even when energy density E of the excitation light was high, the difference between the maintenance factor of the internal quantum efficiency of Lu₂CaMg₂Si₃O₁₂:Ce³⁺ and the maintenance factor of the internal quantum efficiency of YAG:Ce was small. According to the results of Samples 1 and 2, the wavelength conversion member serving as Sample 1 can obtain light having high brightness and superior in color rendering property.

### INDUSTRIAL APPLICABILITY

The light source device according to the present disclosure can be used in, for example, general-purpose lighting devices such as ceiling lights; special lighting devices such as spot lights, stadium lightings, and studio lightings; and vehicular lighting devices such as headlamps. The light source device according to the present disclosure can further be used as a light source in, for example, projection devices such as projectors and head-up displays; endoscope lights; imaging devices such as digital cameras, cell phones, and smartphones;

and liquid crystal display devices such as personal computer (PC) monitors, lap-top personal computers, televisions, portable information terminals (PDXs), smartphones, tablet PCs, and cell phones.

### REFERENCE MARKS IN THE DRAWINGS

10: excitation light source

15: incident optical system

20: wavelength conversion member

25: substrate

30: fluorescence layer

31: first fluorescence layer

32: second fluorescence layer

33: third fluorescence layer

41: first fluorescent substance

42: second fluorescent substance

43: third fluorescent substance

51: first matrix

52: second matrix

53: third matrix

100, 110, 120, 130, 140: light source device

1. A light source device comprising:
an excitation light source; and
a fluorescence layer configured to emit fluorescence by receiving excitation light emitted from the excitation light source,
wherein:
the fluorescence layer includes at least one selected from a group consisting of a first fluorescent substance and a second fluorescent substance, the first fluorescent substance being configured to emit fluorescence having a peak wavelength ranging from 400 nm to 510 nm, inclusive, by receiving the excitation light, the second fluorescent substance being configured to emit fluorescence having a peak wavelength ranging from 580 nm to 700 nm, inclusive, by receiving the excitation light,
the first fluorescent substance and the second fluorescent substance each have a fluorescence lifetime ranging from 0.1 nanoseconds to 250 nanoseconds, inclusive, and
energy density of the excitation light is 10 W/mm² or more.

2. The light source device according to claim 1, wherein the first fluorescent substance includes a chemical compound represented by Lu₃(Ga₁₋ₓAlₓ)₅O₁₂:Ce³⁺, where 0≤x≤1.

3. The light source device according to claim 1, wherein the first fluorescent substance includes at least one selected from a group consisting of a chemical compound represented by Y₃Sc₂(Ga_{1-y}Al_{y})₃O₁₂:Ce³⁺, where 0≤y≤1 and a chemical compound represented by (Ca_{1-z}RE_{z})₃(Zr_{1-w}Sc_{w})₂Sc₃O₁₂:Ce³⁺, where 0≤z≤1, 0≤w≤1, and RE includes at least one selected from a group consisting of Lu, Y, and Gd.

4. The light source device according to claim 1, wherein the second fluorescent substance includes a chemical compound represented by La₃(Si₆₋ₛ, Alₛ)N_{11-1/3)s}:Ce³⁺, where 0≤s≤1.

5. The light source device according to claim 1, wherein the second fluorescent substance includes a chemical compound represented by Lu₂CaMg₂Si₃O₁₂:Ce³⁺.

6. The light source device according to claim 1, wherein the second fluorescent substance includes a chemical compound represented by (Ca, Sr, Ba, Mg)AlSiN₃:Ce³⁺.

7. The light source device according to claim 1, wherein the second fluorescent substance includes at least one selected from a group consisting of a chemical compound represented by CaSiN₂:Ce³⁺, a chemical compound represented by Sr₃Sc₄O₉:Ce³⁺, and a chemical compound represented by GdSr₂AlO₅:Ce³⁺.

8. The light source device according to claim 1, wherein the fluorescence layer further includes a first matrix surrounding the first fluorescent substance.

9. The light source device according to claim 8, wherein the first matrix includes ZnO.

10. The light source device according to claim 1, wherein the fluorescence layer further includes a second matrix surrounding the second fluorescent substance.

11. The light source device according to claim 10, wherein the second matrix includes ZnO.

12. The light source device according to claim 1, wherein the first fluorescent substance is a sintered body of powder of raw materials for the first fluorescent substance.

13. The light source device according to claim 1, wherein the second fluorescent substance is a sintered body of powder of raw materials for the second fluorescent substance.

14. The light source device according to claim 1, wherein the fluorescence layer includes a first fluorescence layer and a second fluorescence layer, the first fluorescence layer including the first fluorescent substance, the second fluorescence layer including the second fluorescent substance.
